(19) United States
(12) Patent Application Publication
(10) Pub. No.: US 2025/0379907 A1
(43) Pub. Date: Dec. 11, 2025

(54) INTER-DEVICE POINT-TO-POINT COMMUNICATION METHOD, SYSTEM AND APPARATUS, DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Wei LIU, Suzhou, Jiangsu (CN); Yaming XU, Suzhou, Jiangsu (CN); Wei GUO, Suzhou, Jiangsu (CN); Deshan ZHANG, Suzhou, Jiangsu (CN); Can ZHANG, Suzhou, Jiangsu (CN)

(21) Appl. No.: 18/876,956

(22) PCT Filed: Dec. 15, 2023
(86) PCT No.: PCT/CN2023/139247

§ 371 Date: Dec. 19, 2024

(30) Foreign Application Priority Data
Feb. 23, 2023 (CN) 202310154607.4

(51) Int. Cl. H04L 67/1061

(52) U.S. Cl. CPC H04L 67/1061

(57) ABSTRACT

A method for peer-to-peer communication between devices is applied to a target transmitting device and includes: obtaining an internal address of a target receiving device, wherein both the target transmitting device and the target receiving device are peripheral component interconnect express (PCIE) devices; according to a preset protocol format, constructing a target protocol that includes the internal address of the target receiving device, and generating a target data packet carrying the target protocol. By the design of the general-purpose target protocol, communications and mutual access between heterogeneous PCIE devices are achieved in the present application without occupying a large number of physical addresses of a host end.

### CROSS-REFERENCE TO RELATED APPLICATION

This application claims the priority of the Chinese Patent application filed on Feb. 23, 2023 before the China National Intellectual Property Administration with the application quantity of 202310154607.4, and the title of “INTER-DEVICE POINT-TO-POINT COMMUNICATION METHOD, SYSTEM AND APPARATUS, DEVICE, AND STORAGE MEDIUM”, which is incorporated herein in its entirety by reference.

### FIELD

The present application relates to the technical field of communications and, more particularly, to a method, system, and apparatus for peer-to-peer communication between devices, a device and a non-transitory computer-readable storage medium.

### BACKGROUND

With the rapid development of emerging high-tech industries such as cloud computation, big data, and artificial intelligence, a network interface rate of a data center is evolving towards 100G and above. A growth rate of a network bandwidth is far greater than a growth rate of computing power of a central processing unit (CPU), so that a CPU-based cloud infrastructure has a bottleneck in a stage of implementing network data forwarding. In many scenarios, a large amount of data generated by different network devices or heterogeneous devices does not actually need to be processed by a CPU. In these scenarios, if all pieces of data need to be processed by the CPU, a proportion of CPU resources consumed by network Input/Output (IO) may increase, and more CPU computing power resources added by the data center may be consumed in network IO processing. An existing peer-to-peer communication method for achieving mutual access without a host may reduce an unnecessary data processing flow generated between different devices by a CPU to an extent, but it requires that communication devices are products from the same manufacturer. Products from different manufacturers do not support peer-to-peer communication and mutual access, and even the products from the same manufacturer still need to occupy a large address space of a host.

### SUMMARY

In view of this, the present application aims to provide a method and apparatus for peer-to-peer communication between devices, a device and a non-transitory computer-readable storage medium, which achieves communication and mutual access between heterogeneous peripheral component interconnect express (PCIE, mainly used for expanding a data throughput of a system bus of a computer and increasing a device communication rate) devices without occupying a large number of physical addresses of a host end. Solutions are as follows.

A method for peer-to-peer communication between devices, applied to a target transmitting device is provided by the embodiments of the present application, which includes:
obtaining an internal address of a target receiving device, wherein both the target transmitting device and the target receiving device are peripheral component interconnect express (PCIE) devices;
according to a preset protocol format, constructing a target protocol that includes the internal address of the target receiving device, and generating a target data packet carrying the target protocol; and
transmitting the target data packet to the target receiving device to cause the target receiving device to: analyze, after receiving the target data packet, the target protocol carried in the target data packet to obtain the internal address, and perform data processing on the internal address.

In some embodiments of the present application, before the step of obtaining the internal address of the target receiving device, the method further includes:
transmitting device key information of the target transmitting device to a host end to cause the host end to: register the target transmitting device and return the internal address of the target receiving device.

In some embodiments of the present application, the device key information of the target transmitting device at least includes a device identification, a type of matched receiving device, a quantity of addresses, an internal available device address, and a callback function.

In some embodiments of the present application, the internal available device address at least includes a host mapping address, an internal address, an address length and an address type.

In some embodiments of the present application, before the step of registering, by the host end, the target transmitting device, the method further includes:
determining whether a preset information transmitting condition is currently satisfied, and in response to the preset information transmitting condition being currently satisfied, transmitting the device key information of the target transmitting device to the host end to cause the host end to execute the step of registering the target transmitting device after the host end has monitored the device key information by using a preset service driver program.

In some embodiments of the present application, the preset service driver program is a program that is run on the host end in advance and performs device registration.

In some embodiments of the present application, the step of transmitting the device key information of the target transmitting device to the host end to cause the host end to execute the step of registering the target transmitting device after the host end has monitored the device key information by using the preset service driver program includes:
transmitting the device key information of the target transmitting device to the host end in a way of calling a pre-generated register function interface to cause the host end to monitor a calling state of the pre-generated register function interface by using the preset service driver program, and in response to it being monitored that the pre-generated register function interface is called, determining that the device key information has been monitored, and executing the step of registering the target transmitting device.

In some embodiments of the present application, the pre-generated register function interface is exported by the preset service driver program through an execution symbol export library function.

In some embodiments of the present application, the execution symbol export library function is an EXPORT_SYMBOL_GPL function.

In some embodiments of the present application, the step of transmitting the device key information of the target transmitting device to the host end to cause the host end to register the target transmitting device includes:
transmitting the device key information of the target transmitting device to the host end to cause the host end to locally store the device key information transmitted by the target transmitting device.

In some embodiments of the present application, after the step of transmitting the device key information of the target transmitting device to the host end to cause the host end to locally store the device key information transmitted by the target transmitting device, the method further includes:
transmitting a device matching instruction to the host end to cause the host end to: match, from registered devices according to the device matching instruction, the target receiving device having a device type consistent with the type of matched receiving device in the device key information transmitted by the target transmitting device, read the internal address in locally stored device key information of the target receiving device, and return the internal address of the target receiving device, wherein the target receiving device has been registered at the host end.

In some embodiments of the present application, the step of obtaining the internal address of the target receiving device includes:
receiving the internal address of the target receiving device and a corresponding address type, which are returned by the host end in a way of calling the callback function in the device key information of the target transmitting device, wherein the host end further transmits the device key information of the target transmitting device to the target receiving device in the way of calling the callback function in the device key information of the target transmitting device.

In some embodiments of the present application, the data processing includes one of reading data in the internal address or writing data into the internal address; a type of the data processing depends on a type of the target data packet received by the target receiving device; and the type of the target data packet depends on the address type of the internal address of the target receiving device.

In some embodiments of the present application, after the step of transmitting the target data packet to the target receiving device to cause the target receiving device to perform data processing on the internal address, the method further includes:
receiving a confirm data packet returned by the target receiving device, wherein the confirm data packet is generated and returned by the target receiving device according to the device key information of the target transmitting device.

In some embodiments of the present application, after the step of obtaining the internal address of the target receiving device, the method further includes:
receiving a host mapping address in the device key information of the target receiving device, which is returned by the host end in the way of calling the callback function in the device key information of the target transmitting device to cause the target data packet to further carry the host mapping address in the device key information of the target receiving device.

In some embodiments of the present application, the step of transmitting the target data packet to the target receiving device includes:
transmitting the target data packet to the target receiving device to cause the target receiving device to: analyze the target data packet to obtain the host mapping address in the device key information of the target receiving device, determine whether the host mapping address is a host mapping address for peer-to-peer communication, and in response to the host mapping address being the host mapping address for peer-to-peer communication, execute the step of performing data processing on the internal address.

In some embodiments of the present application, a data packet transmitted between the target transmitting device and the target receiving device is a total loss package (TLP).

A method for peer-to-peer communication between devices is provided by the embodiments of the present application. which is applied to a target receiving device and includes:
receiving a target data packet that is generated and transmitted by a target transmitting device and carries a target protocol, wherein both the target transmitting device and the target receiving device are PCIE devices; the target protocol is a protocol that is constructed, according to a preset protocol format, after the target transmitting device obtains an internal address of the target receiving device and includes the internal address of the target receiving device; and
analyzing the target protocol carried in the target data packet to obtain the internal address, and performing data processing on the internal address.

A system for peer-to-peer communication between devices is provided by the embodiments of the present application, which includes a target transmitting device and a target receiving device, wherein:
the target transmitting device is configured to: obtain an internal address of the target receiving device, wherein both the target transmitting device and the target receiving device are PCIE devices; according to a preset protocol format, construct a target protocol that includes the internal address of the target receiving device, and generate a target data packet carrying the target protocol; and transmit the target data packet to the target receiving device; and
the target receiving device is configured to: analyze, after receiving the target data packet, the target protocol carried in the target data packet to obtain the internal address, and perform data processing on the internal address.

In some embodiments of the present application, the system for the peer-to-peer communication between the devices further includes a host end;
correspondingly, the target transmitting device is further configured to transmit device key information of the target transmitting device to the host end; and
the host end is configured to: register the target transmitting device and return the internal address of the target receiving device.

In a fourth aspect, an apparatus for peer-to-peer communication between devices is provided in the present application, which is applied to a target transmitting device and includes:
an obtaining module configured to obtain an internal address of a target receiving device, wherein both the target transmitting device and the target receiving device are PCIE devices;
a data packet generation module configured to: according to a preset protocol format, construct a target protocol that includes the internal address of the target receiving device, and generate a target data packet carrying the target protocol; and
a data packet transmitting module configured to transmit the target data packet to the target receiving device to cause the target receiving device to: analyze, after receiving the target data packet, the target protocol carried in the target data packet to obtain the internal address, and perform data processing on the internal address.

An electronic device is provided by the embodiments of the present application. The electronic device includes a processor and a memory, wherein the memory is configured to store a computer program; and the computer program is loaded and executed by the processor to implement the method for the peer-to-peer communication between the devices stated above.

A non-transitory computer-readable storage medium is provided by the embodiments of the present application, the non-transitory computer-readable storage medium stores computer-executable instructions, wherein the computer-executable instructions, when loaded and executed by a processor, implement the method for the peer-to-peer communication between the devices stated above.

In the embodiments of the present application, the target transmitting device first obtains an internal address of a target receiving device, wherein both the target transmitting device and the target receiving device are PCIE devices; according to a preset protocol format, then constructs a target protocol that includes the internal address of the target receiving device, and generates a target data packet carrying the target protocol; and finally transmits the target data packet to the target receiving device to cause the target receiving device to: analyze, after receiving the target data packet, the target protocol carried in the target data packet to obtain the internal address, and perform data processing on the internal address. It may be seen that by the design of the general-purpose target protocol, in the embodiments of the present application, communications and mutual access between heterogeneous PCIE devices are achieved. During peer-to-peer communication between the PCIE devices, the internal address of the target receiving device is decided by the target protocol carried in the target data packet, so that a large number of physical addresses of the host end do not need to be occupied.

### BRIEF DESCRIPTION OF THE DRAWINGS

In order to more clearly explain the technical solution in the embodiment of the present application or in the related art, the drawings which are needed to be used in the description of the embodiments or the related art may be briefly introduced below. Obviously, the drawings in the description below are merely some embodiments of the present application, and a person skilled in the art may obtain other drawings according to the provided drawings without involving any inventive effort.

FIG. 1 is a flowchart of a method for peer-to-peer communication between devices according to an embodiment of the present application;

FIG. 2 is an example diagram of a total loss package (TLP) format according to an embodiment of the present application;

FIG. 3 is an example diagram of a target protocol format according to an embodiment of the present application;

FIG. 4 is a flowchart of a method for peer-to-peer communication between devices according to an embodiment of the present application;

FIG. 5 is a schematic diagram of a method for registering a device according to an embodiment of the present application;

FIG. 6 is a schematic diagram of a method for calling back device key information according to an embodiment of the present application;

FIG. 7 is a schematic diagram of a method for actual communication between devices according to an embodiment of the present application;

FIG. 8 is an example diagram of an address type definition according to an embodiment of the present application;

FIG. 9 is a schematic structural diagram of an apparatus for peer-to-peer communication between devices according to an embodiment of the present application;

FIG. 10 is a structural diagram of an electronic device for peer-to-peer communication between devices according to an embodiment of the present application; and

FIG. 11 is a structural diagram of a non-transitory computer-readable storage medium according to an embodiment of the present application.

### DETAILED DESCRIPTION

The technical solutions in embodiments of the present application are clearly and completely described in the following with reference to the drawings in the embodiments of the present application. Apparently, the described embodiments are merely some rather than all of the embodiments of the present application. All other embodiments obtained by a person of ordinary skill in the art based on the embodiments of the present application without making creative efforts shall fall within the protection scope of the present application.

In the related art, although peer-to-peer communication between heterogeneous devices may temporarily meet a requirement for mutual access without a host, there are still draw backs such as incompatibility and a need for occupying a large address space on a host end. For the above technical defects, a solution for peer-to-peer communication between devices is provided by the present application, by design of a general-purpose target protocol, communications and mutual access between heterogeneous PCIE devices are achieved. During peer-to-peer communication between the PCIE devices, the internal address of the target receiving device is decided by the target protocol carried in the target data packet, so that a large number of physical addresses of the host end do not need to be occupied.

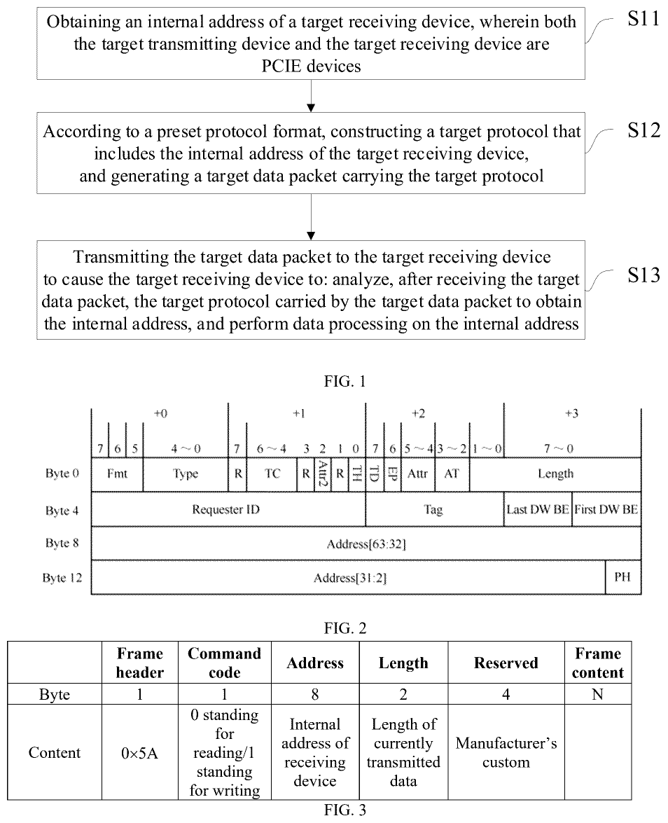

FIG. 1 is a flowchart of a method for peer-to-peer communication between devices according to an embodiment of the present application. Referring to FIG. 1, the method for the peer-to-peer communication between the devices is applied to a target transmitting device and includes:
S11: obtaining an internal address of a target receiving device, wherein both the target transmitting device and the target receiving device are PCIE devices.

In the embodiments of the present application, the target transmitting device obtains the internal address of the target receiving device. Both the target transmitting device and the target receiving device are the PCIE devices, that is, heterogeneous PCIE devices. PCIE is a high-speed serial computer expansion bus standard that belongs to high-speed serial peer-to-peer dual-channel high-bandwidth transmission. The devices connected to the PCIE are allocated with exclusive channel bandwidths and do not share a bus bandwidth. It mainly supports active power management, error reporting, peer-to-peer reliable transmission, hot plugging, Quality of Service (QoS), and other functions. There are two categories of PCIE devices: root port (RP) and endpoint (EP). An RP is equivalent to a root node. A plurality of EP devices are connected to one node and complete data routing, and an EP is an ultimate recipient of data and an executor of commands. A root complex (RC, which is an interface between a central processing unit (CPU) and a PCIe topology) device is configured to connect a CPU/memory subsystem to an I/O device. In an RC mode, a type value in a PCIE configuration header is 1, supporting configuration and I/O transactions. One RC may include a plurality of RPs. For peer-to-peer (i.e. P2P), PCIE-P2P is that one PCIE device directly accesses another PCIE device.

In the embodiments of the present application, before obtaining the internal address of the target receiving device, the target receiving device needs to be registered at a host end. Device key information of the target transmitting device is transmitted to the host end to cause the host end to: register the target transmitting device and return the internal address of the target receiving device. The device key information of the target transmitting device at least includes a device identification, a type of matched receiving device, a quantity of addresses, an internal available device address and a callback function. The internal available device address at least includes a host mapping address, an internal address, an address length and an address type. It should be noted here that the target receiving device also needs to be registered at the host end in the same way. After the target transmitting device transmits its device key information to the host end, the host end monitors the device key information transmitted by the target transmitting device. If the device key information transmitted by the target transmitting device has been monitored, the step of registering the target transmitting device is executed. A register process will be described in detail in the following embodiment.

S12: according to a preset protocol format, constructing a target protocol that includes the internal address of the target receiving device, and generating a target data packet carrying the target protocol.

In the embodiments of the present application, after obtaining the internal address of the target receiving device, the target transmitting device first constructs, according to a preset protocol format, the target protocol that includes the internal address of the target receiving device, and then generates the target data packet carrying the target protocol. The target data packet is a total loss package (TLP), and the target protocol is a specially designed general-purpose communication protocol. Although a receiving device in P2P may receive, according to a mechanism, a TLP transmitted by an original device, an address needs to be located in a bus address of the receiving device. During transmission of a large amount of continuous data, a segment of continuous mapping is required. By setting a general-purpose protocol, this requirement may be effectively avoided. By using the method of the protocol, only a small number of registers are used to avoid the need to occupy a large number of physical addresses of a host during P2P transmission.

FIG. 2 shows a TLP format for a 64-bit memory read-write request, wherein Address represents a destination address (a host mapping address) for transmission. Typically, during direct memory access (DMA) transmission, this value increases according to an amount of data that has been already transmitted. Therefore, during transmission of a large amount of data, a corresponding address space is required. In the embodiments of the present application, this value is only a few values registered by a peer device, and an address that needs to be transmitted to the peer device is determined by the target protocol. Content of the target protocol is shown in FIG. 3.

S13: transmitting the target data packet to the target receiving device to cause the target receiving device to: analyze, after receiving the target data packet, the target protocol carried in the target data packet to obtain the internal address, and perform data processing on the internal address.

In the embodiments of the present application, the target transmitting device transmits the target data packet to the target receiving device to cause the target receiving device to: analyze, after receiving the target data packet, the target protocol carried in the target data packet to obtain the internal address, and perform the data processing on the internal address. In some embodiments of the present application, the target transmitting device may further obtain the host mapping address of the target receiving device while obtaining the internal address of the target receiving device. When generating the TLP, the target transmitting device fills an Address field with the host mapping address. The target receiving device analyzes the target data packet to obtain the host mapping address, and determines whether the host mapping address is a host mapping address for peer-to-peer communication. In response to the host mapping address being the host mapping address for peer-to-peer communication, the target receiving device executes the step of performing data processing on the internal address.

It may be seen that in the embodiments of the present application, the target transmitting device first obtains an internal address of a target receiving device, wherein both the target transmitting device and the target receiving device are PCIE devices; according to a preset protocol format, then constructs a target protocol that includes the internal address of the target receiving device, and generates a target data packet carrying the target protocol; and finally transmits the target data packet to the target receiving device to cause the target receiving device to: analyze, after receiving the target data packet, the target protocol carried in the target data packet to obtain the internal address, and perform data processing on the internal address. By the design of the general-purpose target protocol, in the embodiments of the present application, communications and mutual access between heterogeneous PCIE devices are achieved. During peer-to-peer communication between the PCIE devices, the internal address of the target receiving device is decided by the target protocol carried in the target data packet, so that a large number of physical addresses of the host end do not need to be occupied.

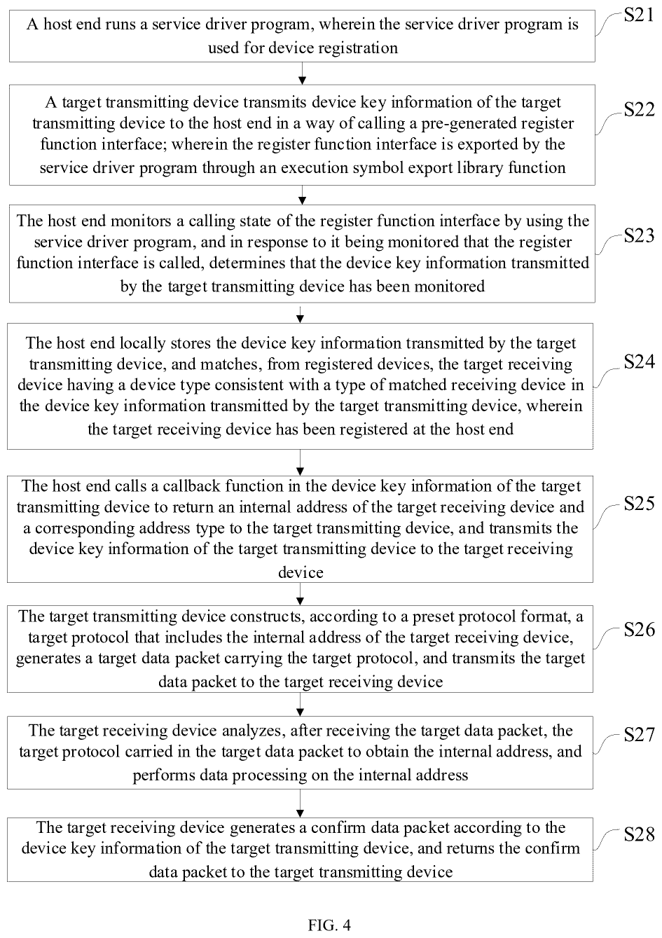

FIG. 4 is a flowchart of a method for peer-to-peer communication between devices according to an embodiment of the present application. Referring to FIG. 4, the method for the peer-to-peer communication between the devices includes:
S21: A host end runs a service driver program, wherein the service driver program is used for device registration.

In the embodiments of the present application, if each piece of device key information supporting the above design is actively collected, it will become extremely complex in the face of many heterogeneous devices. Therefore, an additional service driver program is designed. The service driver program is used for device registration. Firstly, the service driver program needs to be run on the host end, and general-purpose device key information is defined through the way of the service driver program. A device driver only needs to call a small number of interface functions to achieve P2P supporting between different PCIE devices.

S22: A target transmitting device transmits the device key information of the target transmitting device to the host end in a way of calling a pre-generated register function interface; wherein the register function interface is exported by the service driver program through an execution symbol export library function.

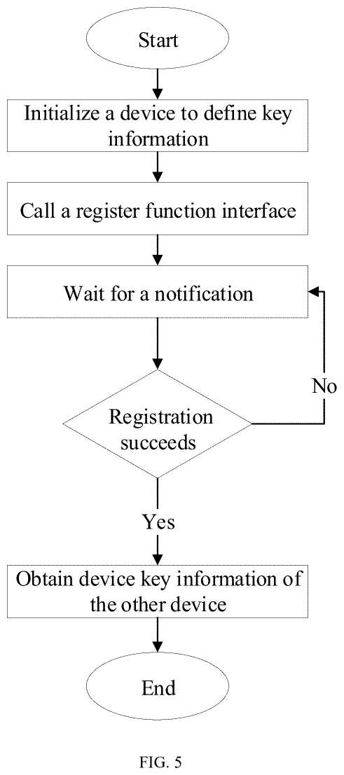

In the embodiments of the present application, the target transmitting device transmits the device key information of the target transmitting device to the host end in the way of calling the pre-generated register function interface. The register function interface is exported by the service driver program through the execution symbol export library function. The execution symbol export library function is an EXPORT_SYMBOL_GPL function. A P2P communication device defines device key information according to its own state and calls the register function interface to register its own device key information in the service driver program. The above process is as shown in FIG. 5. From this, it may be seen that by defining a small amount of general-purpose device key information, the problem of mutual recognition between the target transmitting device and the target receiving device has been solved. Through address information in the device key information, a large address space of a host does not need to be occupied during transmission of a large amount of data.

A data structure of the register function interface is as follows:

```
  struct devinfo{
  U64 unid;// device identification, i.e., different heterogeneous devices have different
unique ids
  U16 Devtype[64]; //type of matched receiving device, i.e., a type of a device expected
to be matched, 0xFFFF represents being invalid
  U8 Num; //quantity of addresses
  struct p2paddr addr[64];// internal available device address
  U8 (* cb)(u64 unid , struct p2paddr *addr, u8 num );// callback function
  };
  wherein a definition of p2paddr is as follows:
  struct p2paddr{
  U64 host; //host mapping address, which is usually a bar address
  U64 dev; //internal address
  U16 len; // address length
  U8 type; // address type
  };
```

S23: The host end monitors a calling state of the register function interface by using the service driver program, and in response to it being monitored that the register function interface is called, determines that the device key information transmitted by the target transmitting device has been monitored.

S24: The host end locally stores the device key information transmitted by the target transmitting device, and matches, from registered devices, the target receiving device having a device type consistent with the type of matched receiving device in the device key information transmitted by the target transmitting device, wherein the target receiving device has been registered at the host end.

S25: The host end calls the callback function in the device key information of the target transmitting device to return the internal address of the target receiving device and a corresponding address type to the target transmitting device, and transmits the device key information of the target transmitting device to the target receiving device.

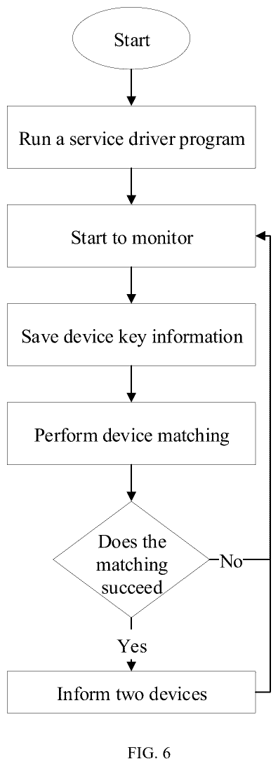

In the embodiments of the present application, the host end monitors the calling state of the register function interface by using the service driver program, and in response to it being monitored that the register function interface is called, determines that the device key information transmitted by the target transmitting device has been monitored. Then, the host end locally stores the device key information transmitted by the target transmitting device, and matches, from the registered devices, the target receiving device having the device type consistent with the type of matched receiving device in the device key information transmitted by the target transmitting device. As mentioned earlier, the target receiving device has been registered at the host end. Namely, after the service driver program receives a device request, the service driver program performs registration and attempts to perform device matching according to the “Devtype” fields in the registered device. After the matching succeeds, the two parties are notified through the callback function in the device key information. The above process is as shown in FIG. 6.

The host end calls the callback function in the device key information of the target transmitting device to return the internal address of the target receiving device and the corresponding address type to the target transmitting device, and transmits the device key information of the target transmitting device to the target receiving device. Namely, the host end reads the internal address in locally stored device key information of the target receiving device and returns the internal address of the target receiving device.

S26: The target transmitting device constructs, according to a preset protocol format, a target protocol that includes the internal address of the target receiving device, generates a target data packet carrying the target protocol, and transmits the target data packet to the target receiving device.

S27: The target receiving device analyzes, after receiving the target data packet, the target protocol carried in the target data packet to obtain the internal address, and performs data processing on the internal address.

S28: The target receiving device generates a confirm data packet according to the device key information of the target transmitting device, and returns the confirm data packet to the target transmitting device.

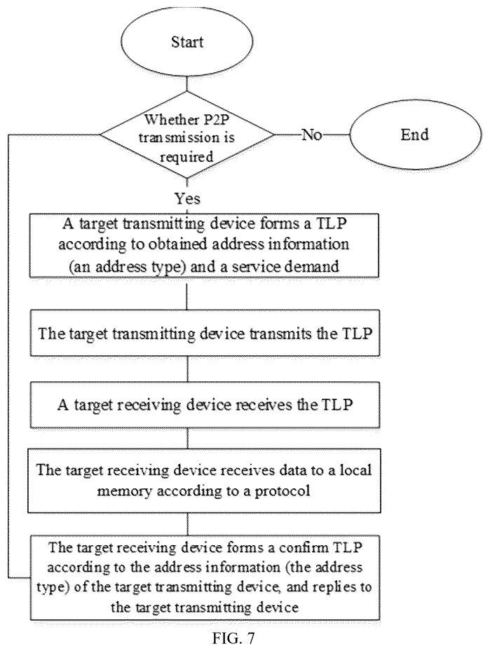

In the embodiments of the present application, the target receiving device generates a confirm data packet according to the device key information of the target transmitting device, and returns the confirm data packet to the target transmitting device. The whole communication process is as shown in FIG. 7.

As mentioned earlier, when the target transmitting device generates the target data packet, the target data packet needs to carry the target protocol, and the Address field needs to be filled with the host mapping address of the peer device. Therefore, when the host end returns information, the host end further needs to return a host mapping address in the device key information of the target receiving device to the target transmitting device, so that the target data packet generated by the target transmitting device also carries the host mapping address in the device key information of the target receiving device. The target receiving device analyzes the target data packet to obtain the host mapping address in the device key information of the target receiving device, and determines whether the host mapping address is a host mapping address for peer-to-peer communication. In response to the host mapping address being the host mapping address for peer-to-peer communication, the target receiving device executes the step of performing data processing on the internal address. Namely, after the target receiving device receives the TLP, if the address in the Address field in the TLP is the host mapping address set by p2p, the target receiving device may further unpack and save data according to the target protocol.

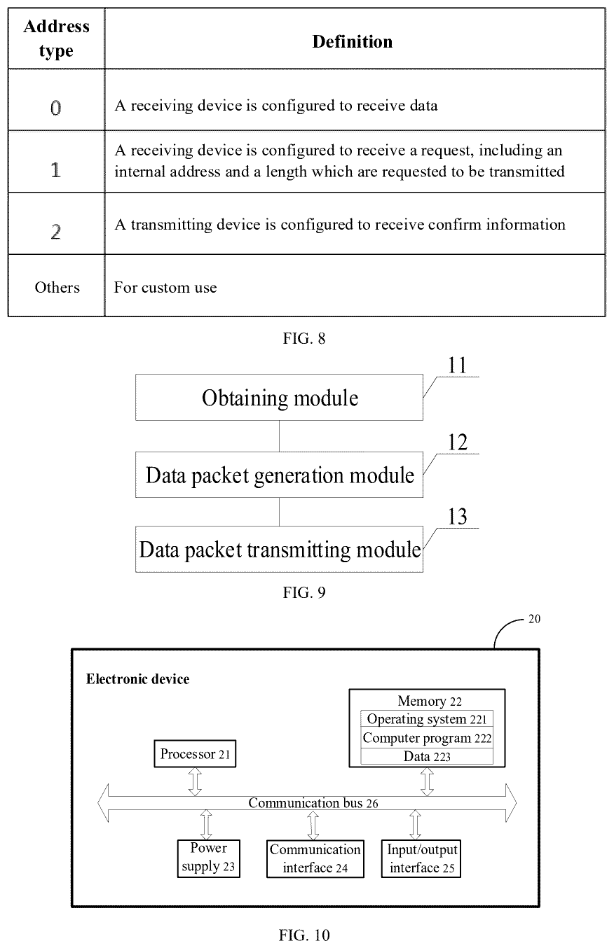

In some embodiments of the present application, there is a limitation on the type of the target data packet, and the type of the target data packet depends on the address type of the internal address of the target receiving device, namely the “U8 type” field. The address type is defined in FIG. 8. The target receiving device reads data in the internal address or writes data into the internal address according to the type of the target data packet. For example, when the address type of the internal address is 0, it indicates that the internal address is used for receiving data, and at this moment, the type of the received TLP is the type of writing data into the internal address.

A method for peer-to-peer communication between devices is correspondingly provided by the embodiments of the present application, and which is applied to a target receiving device and includes:
receiving, by the target receiving device, a target data packet that is generated and transmitted by a target transmitting device and carries a target protocol, wherein both the target transmitting device and the target receiving device are PCIE devices, and the target protocol is a protocol that is constructed, according to a preset protocol format, after the target transmitting device obtains an internal address of the target receiving device and includes the internal address of the target receiving device; and then analyzing the target protocol carried in the target data packet to obtain the internal address and performing data processing on the internal address.

A system for peer-to-peer communication between devices is correspondingly provided by the embodiments of the present application, which includes a target transmitting device and a target receiving device, wherein:
the target transmitting device is configured to: obtain an internal address of the target receiving device, wherein both the target transmitting device and the target receiving device are PCIE devices; according to a preset protocol format, construct a target protocol that includes the internal address of the target receiving device, and generate a target data packet carrying the target protocol; and transmit the target data packet to the target receiving device; and
the target receiving device is configured to: analyze, after receiving the target data packet, the target protocol carried in the target data packet to obtain the internal address, and perform data processing on the internal address.

In some embodiments of the present application, the system for the peer-to-peer communication between the devices further includes a host end.

Correspondingly, the target transmitting device is further configured to transmit device key information of the target transmitting device to the host end; and
the host end is configured to: register the target transmitting device and return the internal address of the target receiving device.

Referring to FIG. 9, an apparatus for peer-to-peer communication between devices is correspondingly provided by the embodiments of the present application, which is applied to a target transmitting device and includes:
an obtaining module 11 configured to obtain an internal address of a target receiving device, wherein both the target transmitting device and the target receiving device are PCIE devices;
a data packet generation module 12 configured to: according to a preset protocol format, construct a target protocol that includes the internal address of the target receiving device, and generate a target data packet carrying the target protocol; and
a data packet transmitting module 13 configured to transmit the target data packet to the target receiving device to cause the target receiving device to: analyze, after receiving the target data packet, the target protocol carried in the target data packet to obtain the internal address, and perform data processing on the internal address.

It may be seen that in the embodiments of the present application, the target transmitting device first obtains an internal address of a target receiving device, wherein both the target transmitting device and the target receiving device are PCIE devices; according to a preset protocol format, then constructs a target protocol that includes the internal address of the target receiving device, and generates a target data packet carrying the target protocol; and finally transmits the target data packet to the target receiving device to cause the target receiving device to: analyze, after receiving the target data packet, the target protocol carried in the target data packet to obtain the internal address, and perform data processing on the internal address. By the design of the general-purpose target protocol, in the embodiments of the present application, communications and mutual access between heterogeneous PCIE devices are achieved. During peer-to-peer communication between the PCIE devices, the internal address of the target receiving device is decided by the target protocol carried in the target data packet, so that a large number of physical addresses of the host end do not need to be occupied.

In some implementations, the apparatus for the peer-to-peer communication between the devices further includes:
a device key information transmitting module configured to: determine whether a preset information transmitting condition is currently satisfied, and in response to the preset information transmitting condition being currently satisfied, transmit the device key information of the target transmitting device to the host end to cause the host end to execute the step of registering the target transmitting device after the host end has monitored the device key information by using a preset service driver program;
a device matching module configured to: transmit a device matching instruction to the host end to cause the host end to: match, from registered devices according to the device matching instruction, the target receiving device having a device type consistent with the type of matched receiving device in the device key information transmitted by the target transmitting device, read the internal address in locally stored device key information of the target receiving device, and return the internal address of the target receiving device, wherein the target receiving device has been registered at the host end;
a confirming module configured to receive a confirm data packet returned by the target transmitting device, wherein the confirm data packet is generated and returned by the target receiving device according to the device key information of the target transmitting device.

In some embodiments, a data packet transmitted between the target transmitting device and the target receiving device in the apparatus for the peer-to-peer communication between the devices is a TLP.

In some embodiments of the present application, an electronic device is further provided in the embodiments of the present application. FIG. 10 is a structural diagram of an electronic device 20 according to an exemplary embodiment. Content in the figure cannot be considered as any limitation on the use scope of the present application.

FIG. 10 is a schematic structural diagram of an electronic device 20 according to an embodiment of the present application. The electronic device 20 may include: at least one processor 21, at least one memory 22, a power supply 23, a communication interface 24, an input/output interface 25 and a communication bus 26. The memory 22 is configured to store a computer program, and the computer program is loaded and executed by the processor 21 to at least implement the following steps:
obtaining an internal address of a target receiving device, wherein both the target transmitting device and the target receiving device are PCIE devices;
according to a preset protocol format, constructing a target protocol that includes the internal address of the target receiving device, and generating a target data packet carrying the target protocol; and
transmitting the target data packet to the target receiving device to cause the target receiving device to: analyze, after receiving the target data packet, the target protocol carried in the target data packet to obtain the internal address, and perform data processing on the internal address.

In some embodiments of the present application, before the step of obtaining the internal address of the target receiving device, the method further includes:
transmitting device key information of the target transmitting device to a host end to cause the host end to: register the target transmitting device and return the internal address of the target receiving device.

In some embodiments of the present application, the device key information of the target transmitting device at least includes a device identification, a type of matched receiving device, a quantity of addresses, an internal available device address, and a callback function.

In some embodiments of the present application, the internal available device address at least includes a host mapping address, an internal address, an address length and an address type.

In some embodiments of the present application, before the step of registering, by the host end, the target transmitting device, the method further includes:
determining whether a preset information transmitting condition is currently satisfied, and in response to the preset information transmitting condition being currently satisfied, transmitting the device key information of the target transmitting device to the host end to cause the host end to execute the step of registering the target transmitting device after the host end has monitored the device key information by using a preset service driver program.

In some embodiments of the present application, the preset service driver program is a program that is run on the host end in advance and performs device registration.

In some embodiments of the present application, the step of transmitting the device key information of the target transmitting device to the host end to cause the host end to execute the step of registering the target transmitting device after the host end has monitored the device key information by using the preset service driver program includes:
transmitting the device key information of the target transmitting device to the host end in a way of calling a pre-generated register function interface to cause the host end to monitor a calling state of the register function interface by using the preset service driver program, and in response to it being monitored that the pre-generated register function interface is called, determining that the device key information has been monitored, and executing the step of registering the target transmitting device.

In some embodiments of the present application, the pre-generated register function interface is exported by the preset service driver program through an execution symbol export library function.

In some embodiments of the present application, the execution symbol export library function is an EXPORT_SYMBOL_GPL function.

In some embodiments of the present application, the step of transmitting the device key information of the target transmitting device to the host end to cause the host end to register the target transmitting device includes:
transmitting the device key information of the target transmitting device to the host end to cause the host end to locally store the device key information transmitted by the target transmitting device.

In some embodiments of the present application, after the step of transmitting the device key information of the target transmitting device to the host end to cause the host end to locally store the device key information transmitted by the target transmitting device, the method further includes:
transmitting a device matching instruction to the host end to cause the host end to: match, from registered devices according to the device matching instruction, the target receiving device having a device type consistent with the type of matched receiving device in the device key information transmitted by the target transmitting device, read the internal address in locally stored device key information of the target receiving device, and return the internal address of the target receiving device, wherein the target receiving device has been registered at the host end.

In some embodiments of the present application, the step of obtaining the internal address of the target receiving device includes:
receiving the internal address of the target receiving device and the corresponding address type, which are returned by the host end in a way of calling the callback function in the device key information of the target transmitting device, wherein the host end further transmits the device key information of the target transmitting device to the target receiving device in the way of calling the callback function in the device key information of the target transmitting device.

In some embodiments of the present application, the data processing includes one of reading data in the internal address or writing data into the internal address; a type of the data processing depends on a type of the target data packet received by the target receiving device; and the type of the target data packet depends on the address type of the internal address of the target receiving device.

In some embodiments of the present application, after the step of transmitting the target data packet to the target receiving device to cause the target receiving device to perform data processing on the internal address, the method further includes:
receiving a confirm data packet returned by the target transmitting device, wherein the confirm data packet is generated and returned by the target receiving device according to the device key information of the target transmitting device.

In some embodiments of the present application, after the step of obtaining the internal address of the target receiving device, the method further includes:
receiving a host mapping address in the device key information of the target receiving device, which is returned by the host end in the way of calling the callback function in the device key information of the target transmitting device to cause the target data packet to further carry the host mapping address in the device key information of the target receiving device.

In some embodiments of the present application, the step of transmitting the target data packet to the target receiving device includes:
transmitting the target data packet to the target receiving device to cause the target receiving device to: analyze the target data packet to obtain the host mapping address in the device key information of the target receiving device, and determine whether the host mapping address is a host mapping address for peer-to-peer communication; and in response to the host mapping address being the host mapping address for peer-to-peer communication, execute the step of performing data processing on the internal address.

In some embodiments of the present application. the data packet transmitted between the target transmitting device and the target receiving device is a TLP.

In the embodiments of the present application. the power supply 23 is configured to provide operating voltage for hardware devices on the electronic device 20. The communication interface 24 may create a data transmission channel between the electronic device 20 and an external device, and a communication protocol followed by the data transmission channel may be any communication protocol applicable to the technical solutions of the present application, and will not be limited here. The input/output interface 25 is configured to obtain data input from the outside or data output to the outside. An interface type of the input/output interface may be selected according to an application need, and will not be limited here.

In addition, the memory 22 serves as a carrier for resource storage, which may be a read-only memory, a random access memory, a magnetic disk or a compact disc. Resources stored on the memory may include an operating system 221, a computer program 222, data 223, and the like. A storage mode may be short-term storage or permanent storage.

The operating system 221 is configured to manage and control the hardware devices and the computer program 222 on the electronic device 20, to achieve operation and processing on massive data 223 in the memory 22 by the processor 21. The operating system 221 may be Windows Server. Netware, Unix, Linux, and the like. The computer program 222 may further include a computer program configured to complete other operations in addition to including a computer program that is used for implementing the method for peer-to-peer communication between devices, which is provided in any of the foregoing embodiments and is performed by the electronic device 20. The data 223 may include the internal address collected by the electronic device 20.

In some embodiments of the present application, a non-transitory computer-readable storage medium is further provided by the embodiments of the present application, the non-transitory computer-readable storage medium has a computer program stored thereon. The computer program, when loaded and executed by a processor, at least implements the following steps:
obtaining an internal address of a target receiving device, wherein both the target transmitting device and the target receiving device are PCIE devices;
according to a preset protocol format, constructing a target protocol that includes the internal address of the target receiving device, and generating a target data packet carrying the target protocol; and
transmitting the target data packet to the target receiving device to cause the target receiving device to: analyze, after receiving the target data packet, the target protocol carried in the target data packet to obtain the internal address, and perform data processing on the internal address. In some embodiments of the present application, before the step of obtaining the internal address of the target receiving device, the method further includes:
transmitting device key information of the target transmitting device to a host end, to cause the host end to: register the target transmitting device and return the internal address of the target receiving device.

In some embodiments of the present application, the device key information of the target transmitting device at least includes a device identification, a type of matched receiving device, a quantity of addresses, an internal available device address, and a callback function.

In some embodiments of the present application, the internal available device address at least includes a host mapping address, an internal address, an address length, and an address type.

In some embodiments of the present application, before the step of registering, by the host end, the target transmitting device, the method further includes:
determining whether a preset information transmitting condition is currently satisfied, and in response to the preset information transmitting condition being currently satisfied, transmitting the device key information of the target transmitting device to the host end to cause the host end to execute the step of registering the target transmitting device after the host end has monitored the device key information by using a preset service driver program.

In some embodiments of the present application, the preset service driver program is a program that is run on the host end in advance and performs device registration.

In some embodiments of the present application, the step of transmitting the device key information of the target transmitting device to the host end to cause the host end to execute the step of registering the target transmitting device after the host end has monitored the device key information by using the preset service driver program includes:
transmitting the device key information of the target transmitting device to the host end in a way of calling a pre-generated register function interface to cause the host end to monitor a calling state of the register function interface by using the preset service driver program, and in response to it being monitored that the register function interface is called, determining that the device key information has been monitored, and executing the step of registering the target transmitting device.

In some embodiments of the present application, the register function interface is exported by the preset service driver program through an execution symbol export library function.

In some embodiments of the present application, the execution symbol export library function is an EXPORT_SYMBOL_GPL function.

In some embodiments of the present application, the step of transmitting the device key information of the target transmitting device to the host end to cause the host end to register the target transmitting device includes:
transmitting the device key information of the target transmitting device to the host end to cause the host end to locally store the device key information transmitted by the target transmitting device.

In some embodiments of the present application, after the step of transmitting the device key information of the target transmitting device to the host end to cause the host end to locally store the device key information transmitted by the target transmitting device, the method further includes:
transmitting a device matching instruction to the host end to cause the host end to: match, from registered devices according to the device matching instruction, the target receiving device having a device type consistent with the type of matched receiving device in the device key information transmitted by the target transmitting device, read the internal address in locally stored device key information of the target receiving device, and return the internal address of the target receiving device, wherein the target receiving device has been registered at the host end.

In some embodiments of the present application, the step of obtaining the internal address of the target receiving device includes:
receiving the internal address of the target receiving device and the corresponding address type, which are returned by the host end in a way of calling the callback function in the device key information of the target transmitting device, wherein the host end further transmits the device key information of the target transmitting device to the target receiving device in the way of calling the callback function in the device key information of the target transmitting device.

In some embodiments of the present application, the data processing includes one of reading data in the internal address or writing data into the internal address; a type of the data processing depends on a type of the target data packet received by the target receiving device; and the type of the target data packet depends on the address type of the internal address of the target receiving device.

In some embodiments of the present application, after the step of transmitting the target data packet to the target receiving device to cause the target receiving device to perform data processing on the internal address, the method further includes:
receiving a confirm data packet returned by the target transmitting device, wherein the confirm data packet is generated and returned by the target receiving device according to the device key information of the target transmitting device.

In some embodiments of the present application, after the step of obtaining the internal address of the target receiving device, the method further includes:
receiving a host mapping address in the device key information of the target receiving device, which is returned by the host end in the way of calling the callback function in the device key information of the target transmitting device to cause the target data packet to further carry the host mapping address in the device key information of the target receiving device.

In some embodiments of the present application, the step of transmitting the target data packet to the target receiving device includes:
transmitting the target data packet to the target receiving device to cause the target receiving device to: analyze the target data packet to obtain the host mapping address in the device key information of the target receiving device, and determine whether the host mapping address is a host mapping address for peer-to-peer communication; and in response to the host mapping address being the host mapping address for peer-to-peer communication, execute the step of performing data processing on the internal address.

In some embodiments of the present application, a data packet transmitted between the target transmitting device and the target receiving device is a TLP.

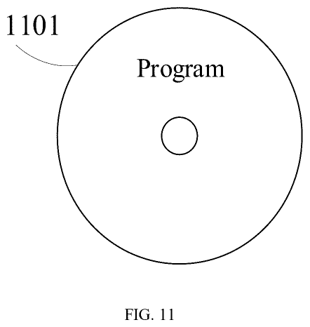

A non-transitory computer-readable storage medium is further provided by the embodiments of the present application, as shown in FIG. 11, the non-transitory computer-readable storage medium has a computer program 1101 stored thereon. The computer program 1101, when executed by a processor, performs the processes of the above data obtaining method embodiment and may achieve the same technical effect, in order to avoid repetition, it may not be elaborated further here. The non-transitory computer-readable storage medium includes, for example, a read-only memory (ROM), a random access memory (RAM), a magnetic disk, or a compact disc.

The various embodiments in the present specification are described in a progressive manner, and each embodiment focuses on differences from other embodiments. The same or similar parts between all the embodiments may be referred to each other. Since the apparatus provided in the embodiments correspond to the method provided in the embodiments, the apparatus is described simply, and related parts are found in some of the explanations of the method.

Finally, it should be further noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device. Without more constraints, an element limited by “includes a . . . ” does not preclude the existence of additional identical elements in the process, method, product, or device that includes the element.

The method, system and apparatus for peer-to-peer communication between devices, and the device and the non-transitory computer-readable storage medium have been described in detail above. Examples are used herein to illustrate the principles and implementations of the present application. The descriptions of the above embodiments are only used to help understand the method of the present application and its core idea; and at the same time, a person skilled in the art may make changes to all the implementations and application scopes according to the idea of the present application. In summary, the content of the present specification should not be understood as a limitation on the present application.

1. A method for peer-to-peer communication between devices, applied to a target transmitting device and comprising:
obtaining an internal address of a target receiving device, wherein both the target transmitting device and the target receiving device are peripheral component interconnect express (PCIE) devices;
according to a preset protocol format, constructing a target protocol that comprises the internal address of the target receiving device, and generating a target data packet carrying the target protocol; and
transmitting the target data packet to the target receiving device to cause the target receiving device to: analyze, after receiving the target data packet, the target protocol carried in the target data packet to obtain the internal address, and perform data processing on the internal address.

2. The method for the peer-to-peer communication between the devices according to claim 1, wherein before the step of obtaining the internal address of the target receiving device, the method further comprises:
transmitting device key information of the target transmitting device to a host end to cause the host end to: register the target transmitting device and return the internal address of the target receiving device.

3. The method for the peer-to-peer communication between the devices according to claim 2, wherein the device key information of the target transmitting device at least comprises a device identification, a type of matched receiving device, a quantity of addresses, an internal available device address, and a callback function.

4. The method for the peer-to-peer communication between the devices according to claim 3, wherein the internal available device address at least comprises a host mapping address, an internal address, an address length and an address type.

5. The method for the peer-to-peer communication between the devices according to claim 4, wherein before the step of registering, by the host end, the target transmitting device, the method further comprises:
determining whether a preset information transmitting condition is currently satisfied, and in response to the preset information transmitting condition being currently satisfied, transmitting the device key information of the target transmitting device to the host end to cause the host end to execute the step of registering the target transmitting device after the host end has monitored the device key information by using a preset service driver program.

6. The method for the peer-to-peer communication between the devices according to claim 5, wherein the preset service driver program is a program that is run on the host end in advance and performs device registration.

7. The method for the peer-to-peer communication between the devices according to claim 5, wherein the step of transmitting the device key information of the target transmitting device to the host end to cause the host end to execute the step of registering the target transmitting device after the host end has monitored the device key information by using the preset service driver program comprises:
transmitting the device key information of the target transmitting device to the host end in a way of calling a pre-generated register function interface to cause the host end to monitor a calling state of the pre-generated register function interface by using the preset service driver program, and in response to it being monitored that the pre-generated register function interface is called, determining that the device key information has been monitored, and executing the step of registering the target transmitting device.

8. The method for the peer-to-peer communication between the devices according to claim 7, wherein the pre-generated register function interface is exported by the preset service driver program through an execution symbol export library function.

9. The method for the peer-to-peer communication between the devices according to claim 8, wherein the execution symbol export library function is an EXPORT_SYMBOL_GPL function.

10. The method for the peer-to-peer communication between the devices according to claim 4, wherein the step of transmitting the device key information of the target transmitting device to the host end to cause the host end to register the target transmitting device comprises:
transmitting the device key information of the target transmitting device to the host end to cause the host end to locally store the device key information transmitted by the target transmitting device.

11. The method for the peer-to-peer communication between the devices according to claim 10, wherein after the step of transmitting the device key information of the target transmitting device to the host end to cause the host end to locally store the device key information transmitted by the target transmitting device, the method further comprises:
transmitting a device matching instruction to the host end to cause the host end to: match, from registered devices according to the device matching instruction, the target receiving device having a device type consistent with the type of matched receiving device in the device key information transmitted by the target transmitting device, read the internal address in locally stored device key information of the target receiving device, and return the internal address of the target receiving device, wherein the target receiving device has been registered at the host end.

12. The method for the peer-to-peer communication between the devices according to claim 11, wherein the step of obtaining the internal address of the target receiving device comprises:
receiving the internal address of the target receiving device and a corresponding address type, which are returned by the host end in a way of calling the callback function in the device key information of the target transmitting device, wherein the host end further transmits the device key information of the target transmitting device to the target receiving device in the way of calling the callback function in the device key information of the target transmitting device.

13. The method for the peer-to-peer communication between the devices according to claim 12, wherein the data processing comprises one of reading data in the internal address or writing data into the internal address; a type of the data processing depends on a type of the target data packet received by the target receiving device; and the type of the target data packet depends on the address type of the internal address of the target receiving device.

14. The method for the peer-to-peer communication between the devices according to claim 13, wherein after the step of transmitting the target data packet to the target receiving device to cause the target receiving device to perform data processing on the internal address, the method further comprises:
receiving a confirm data packet returned by the target receiving device, wherein the confirm data packet is generated and returned by the target receiving device according to the device key information of the target transmitting device.

15. The method for the peer-to-peer communication between the devices according to claim 12, wherein after the step of obtaining the internal address of the target receiving device, the method further comprises:
receiving a host mapping address in the device key information of the target receiving device, which is returned by the host end in the way of calling the callback function in the device key information of the target transmitting device to cause the target data packet to further carry the host mapping address in the device key information of the target receiving device.

16. The method for the peer-to-peer communication between the devices according to claim 15, wherein the step of transmitting the target data packet to the target receiving device comprises:
transmitting the target data packet to the target receiving device to cause the target receiving device to: analyze the target data packet to obtain the host mapping address in the device key information of the target receiving device, determine whether the host mapping address is a host mapping address for peer-to-peer communication, and in response to the host mapping address being the host mapping address for peer-to-peer communication, execute the step of performing data processing on the internal address.

17. (canceled)

18. A method for peer-to-peer communication between devices, applied to a target receiving device and comprising:
receiving a target data packet that is generated and transmitted by a target transmitting device and carries a target protocol, wherein both the target transmitting device and the target receiving device are PCIE devices; the target protocol is a protocol that is constructed, according to a preset protocol format, after the target transmitting device obtains an internal address of the target receiving device and comprises the internal address of the target receiving device; and
analyzing the target protocol carried in the target data packet to obtain the internal address, and performing data processing on the internal address.

19. (canceled)

20. A system for peer-to-peer communication between devices, comprising a target transmitting device and a target receiving device, wherein:
the target transmitting device is configured to: obtain an internal address of the target receiving device, wherein both the target transmitting device and the target receiving device are PCIE devices; according to a preset protocol format, construct a target protocol that comprises the internal address of the target receiving device, and generate a target data packet carrying the target protocol; and transmit the target data packet to the target receiving device; and
the target receiving device is configured to: analyze, after receiving the target data packet, the target protocol carried in the target data packet to obtain the internal address, and perform data processing on the internal address.

21-24. (canceled)

25. An electronic device, comprising a processor and a memory, wherein the memory is configured to store a computer program; and the computer program is loaded and executed by the processor to implement the method for the peer-to-peer communication between the devices according to claim 1.

26. A non-transitory computer-readable storage medium, configured to store computer-executable instructions, wherein the computer-executable instructions, in response to being loaded and executed by a processor, implement the method for the peer-to-peer communication between the devices according to claim 1.
